(19) United States
(12) Patent Application Publication
(10) Pub. No.: US 2024/0268247 A1
(43) Pub. Date: Aug. 15, 2024

(54) Treatment Systems and Associated Methods

(71) Applicant: Lisi Global, Inc., Richland, WA (US)

(72) Inventors: Jason D. Crisp, Newark, DE (US); Gordon J. McComb, Kennewick, WA (US)

(73) Assignee: Lisi Global, Inc., Richland, WA (US)

(21) Appl. No.: 18/577,651

(22) PCT Filed: Jul. 14, 2022
(86) PCT No.: PCT/US2022/037154

§ 371 Date: Jan. 8, 2024

Related U.S. Application Data
(60) Provisional application No. 63/222,246, filed on Jul. 15, 2021.

(51) Int. Cl. A01B 47/00; A01B 21/08

(52) U.S. Cl. CPC A01B 47/00; A01B 21/08

(57) ABSTRACT

Treatment systems and associated methods are described. According to one aspect, a treatment system includes a frame, a motion assembly coupled with the frame, and wherein the motion assembly is configured to enable the treatment apparatus to move to traverse over ground of a treatment location, and an electrode assembly coupled with the frame, and wherein the electrode assembly comprises a plurality of electrodes configured to apply electrical energy to the ground of the treatment location during the traversal of the treatment location by the treatment system.

### RELATED PATENT DATA

This application claims the benefit of U.S. Provisional Patent Application Ser. No. 63/222,246, filed Jul. 15, 2021, titled “Treatment Apparatus and Associated Treatment Methods,” the disclosure of which is incorporated herein by reference.

### TECHNICAL FIELD

This disclosure relates to treatment systems and associated methods.

### BACKGROUND OF THE DISCLOSURE

Organisms that are harmful to plants, crops, grass sporting surfaces, etc. occur naturally in the soil. Example harmful organisms include bacteria, viruses, fungus, worms, and insects. More specific examples of harmful organisms include the phylum nematoda (round worms) and different fungi including molds, yeasts, and mushrooms that typically cause the most severe crop losses in the world.

The use of resistant plant cultivars, and the eradication of fungi through the use of assorted cultural practices are some of the more well-known approaches which have been employed to address the diseases caused by various fungal pathogens. However, in many situations these well-known measures cannot be employed.

There are many different types and chemical classes of fungicides currently available. The current literature reports that fumigants, sometimes in conjunction with other chemical mitigants, have been the traditional means for controlling fungal plant pathogens and other plant pathogens and pests. Currently, fumigants are still used to control fungal pathogens in many countries, including the United States. However, the high cost of the available fumigants has restricted their use to high value crops in countries where these admittedly toxic products can be applied safely and effectively. Many countries have as of late severely restricted the use of fumigants, or completely banned them altogether as they have been recognized as a health and environmental hazard.

Some embodiments of the present disclosure described herein are directed towards commercially viable and environmentally friendly systems, apparatus and associated methods of controlling harmful organisms in-situ in a treatment location, and that are viable alternatives to conventional control methods in agriculture.

### BRIEF DESCRIPTION OF THE DRAWINGS

Example embodiments of the disclosure are described below with reference to the following accompanying drawings.

FIG. 1 is a perspective view of a treatment system according to one embodiment.

FIG. 2 is a perspective view of underside components of a treatment system according to one embodiment.

FIG. 3 is a perspective view of an upper side of a treatment system according to one embodiment.

FIG. 4 is a perspective view of a hub assembly according to one embodiment.

FIG. 5 is a perspective view of an electrode assembly according to one embodiment.

FIG. 6 is a perspective view of electrodes and plants in a treatment location according to one embodiment.

FIG. 7 is a perspective view of angled electrodes according to one embodiment.

FIG. 8 is a perspective view of a front portion of a treatment apparatus engaged with a treatment location according to one embodiment.

FIG. 9 is a perspective view of front and rear portions of a treatment apparatus engaged with a treatment location according to one embodiment.

FIG. 10 is a perspective view of front and rear portions of a treatment apparatus engaged with a treatment location according to one embodiment.

FIG. 11 is a perspective view of a coupling assembly according to one embodiment.

FIG. 12 is a perspective view of a coupling assembly joining a treatment apparatus and a tow unit according to one embodiment.

FIG. 13 is a perspective view of an underside of an electrode assembly according to one embodiment.

FIG. 14 is a perspective view of a top side of an electrode assembly according to one embodiment.

### DETAILED DESCRIPTION OF THE DISCLOSURE

Example organism treatment systems described herein includes a treatment apparatus configured to efficiently and effectively apply electrical energy from a discharge assembly to a treatment location. Example treatment locations include any volume, type, or condition of air, soil, water, or growing media, planted or fallow field and where a tree, vine, grass, weed, sports grass turf (e.g., golf turf), annual or perennial plant, or commodity may be present, or any type or condition of planting suitable for reception of electrical energy from the treatment apparatus. The treatment apparatuses and associated methods described herein may be utilized in many areas of horticulture as well as for treatment of commodities such as seeds, seedlings, saplings, starts, or plugs.

In some embodiments described herein, plural electrodes of the treatment apparatus engage the treatment location and deliver electrical energy to a target volume between the electrodes to control harmful organisms or otherwise provide a desired outcome at the treatment location that results in a reduction of the harmful organisms and increases plant vigor and growth. In some embodiments, the treatment apparatus and methods are designed to control, manage, reduce or eliminate harmful organisms by applying electrical energy to the treatment location where they reside to disrupt neurological signals of the target organism or physically alter the target organism's cellular structures.

The treatment apparatus may be configured to be stationary or mobile, constructed of steel, aluminum, composite materials (i.e., carbon fiber), plastic or any other structurally-suitable material. An example mobile treatment apparatus may have a motion assembly including one or more wheels on which to traverse the ground of a treatment location, and may additionally include actuators, hydraulics, mechanics, gravity or other devices by which to orient the electrodes of the apparatus for engagement with the treatment location by changing pitch, roll, and/or yaw, and/or maneuvering or manipulating the electrodes vertically, longitudinally or laterally so as to deliver the electrical energy to the treatment location.

As discussed herein, an example mobile treatment apparatus may be towed by a tow unit or carried by any ground-traversing vehicle or machine that pulls, pushes, carries or otherwise moves and maneuvers the treatment apparatus to traverse a treatment location during delivery of electrical energy to the treatment location. The ground-traversing tow unit may be electrically isolated from the treatment apparatus according to some embodiments described below. The tow unit of the treatment system may be human-driven, self-propelled, self-contained, autonomous and/or controlled remotely by a human or computer using artificial intelligence, sonar, GPS, or other means of locational or spatial intelligence in illustrative embodiments.

In one embodiment, the treatment apparatus creates a moving electrical pathway in along a swath of the treatment location in order to deliver electrical energy to a relatively large in-situ location, such as an agricultural field, golf green, or sports field. This is achieved according to some embodiments herein by moving electrodes through the material of the treatment location (i.e., soil, root matter, minerals, water, air, etc. or any combination thereof) and relies on the current and voltage carrying capabilities of the treatment location as well as the resistance of the material of the treatment location to complete the circuit of the discharge assembly.

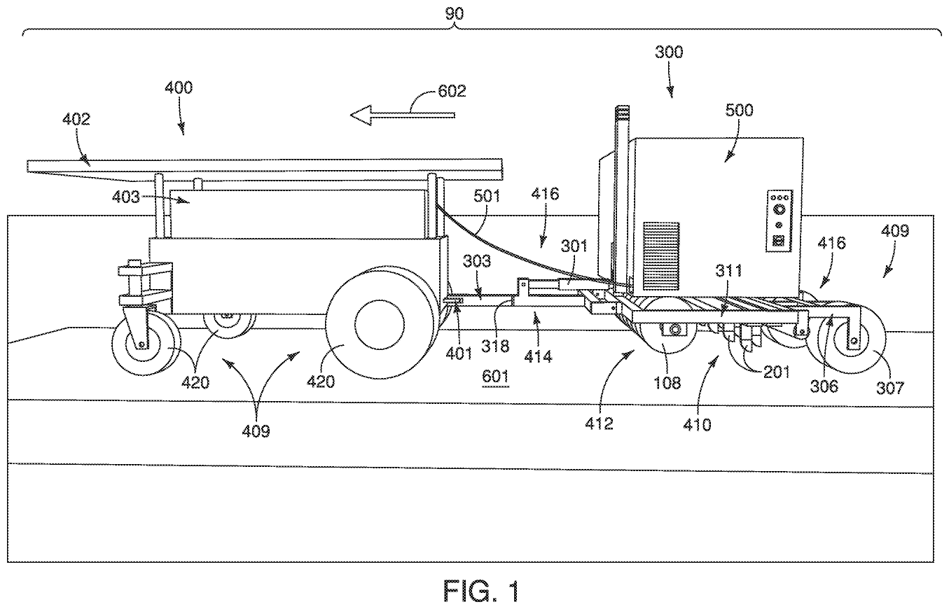

Referring to FIG. 1, a treatment system 90 including a treatment apparatus 300, an associated tow unit 400, and a coupling assembly 414 are shown according to one embodiment. In FIG. 1, the tow unit 400 includes an internal motor (not shown) that propels unit 400 while traversing over ground of a treatment location 601 in a direction of travel 602. The system 90 of FIG. 1 additionally includes a hitch 401 of tow unit 400 and a drawbar 303 of treatment apparatus 300 coupled with the hitch 401.

The treatment system 90 includes a motion assembly 409 that is configured to enable the treatment system 90 to move to traverse over ground of treatment location 601. The illustrated motion assembly 409 includes a wheel carriage 306 and plural tires 307 of treatment apparatus 300 and tires 420 of tow unit 400 to facilitate movement of the apparatus 300 along the treatment location 601. The treatment reduces or eliminates the presence of various organisms or pests present at the treatment location 601. In other embodiments, the treatment apparatus 300 and tow unit 400 are combined into a single unitary apparatus.

In one embodiment, the illustrated unit 400 carries a source of electrical energy in the form of an energy storage unit 403 (e.g., a plurality of rechargeable batteries) and solar panel 402. The batteries may be configured or connected in series or in parallel, or a combination of several sets of batteries may be provided which are connected in series and those sets connected in parallel. Solar panel 402 is used to generate charging electrical energy for charging of energy storage unit 403.

In other embodiments, the source of electrical energy may be in the form of a fossil fuel generator or a power take-off generator. In addition, depleted batteries of the energy storage unit 403 may be replaced with freshly charged batteries as the depleted batteries are recharged. The process of swapping depleted batteries for fresh batteries allows for nearly continuous delivery of electrical energy via treatment apparatus 300 to a treatment location.

The treatment apparatus 300 includes a discharge assembly 500, an electrode assembly 410, a preconditioning assembly 412, a coupling assembly 414, a positioning assembly 416 and a grooming assembly 308 in the depicted arrangement. Other arrangements of treatment apparatus are possible including more, less and/or alternative components, such as housing an energy storage unit.

Discharge assembly 500 is configured to receive operational electrical energy from energy storage unit 403 by way of interface cables 501. Discharge assembly 500 is configured to control the application of electrical energy to the ground of the treatment location 601 via electrode assembly 410 as discussed below. Electrode assembly 410 includes a plurality of electrodes 201 configured to apply electrical energy to the ground of the treatment location 601 during the traversal of the treatment location 601 by the treatment system 90 in one embodiment.

The illustrated preconditioning assembly 412 is arranged to engage the treatment location 601 prior to the electrode assembly 410 as the treatment apparatus 300 moves along direction of travel 602. Preconditioning assembly 412 includes a plurality of pre-slicing members 108 in one embodiment that are configured to form disruptions 601 in the surface of the ground of the treatment location 601 prior to engagement of the electrodes 201 with the treatment location 601. In one embodiment, the pre-slicing members are configured as rotating discs although the members 108 can have other configurations in other embodiments. In addition, the preconditioning assembly 412 is configured to form the disruptions 604 in the form of grooves in the ground of the treatment location 601. The members 108 are positioned at a plurality of different locations aligned with the electrodes 201 in a lateral direction across a swath of treatment location 601 in a direction substantially perpendicular to the direction of travel 602 of the treatment system 90. Members 108 are metal in one embodiment.

Coupling assembly 414 is configured to couple the tow unit 400 and treatment apparatus 300 together to enable tow unit 400 to tow treatment apparatus 300 during treatment operations. In some embodiments discussed below, the coupling assembly 414 is also configured to electrically isolate the coupled tow unit 400 and treatment apparatus 300 from one another.

Positioning assembly 416 is configured to adjust the positioning of frame 311 and components mounted thereto relative to the ground of the treatment location 601 in the illustrated embodiment and as discussed further below.

Grooming assembly 308 is configured to condition the surface of the ground of the treatment location 601 following disruption of the ground of the treatment location 601 by the electrode assembly 410 and preconditioning assembly 412.

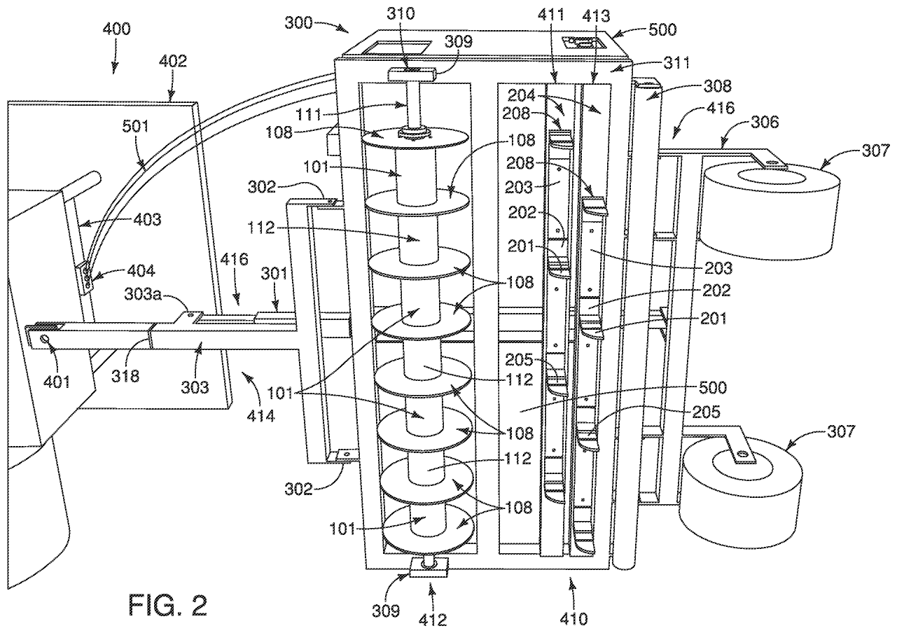

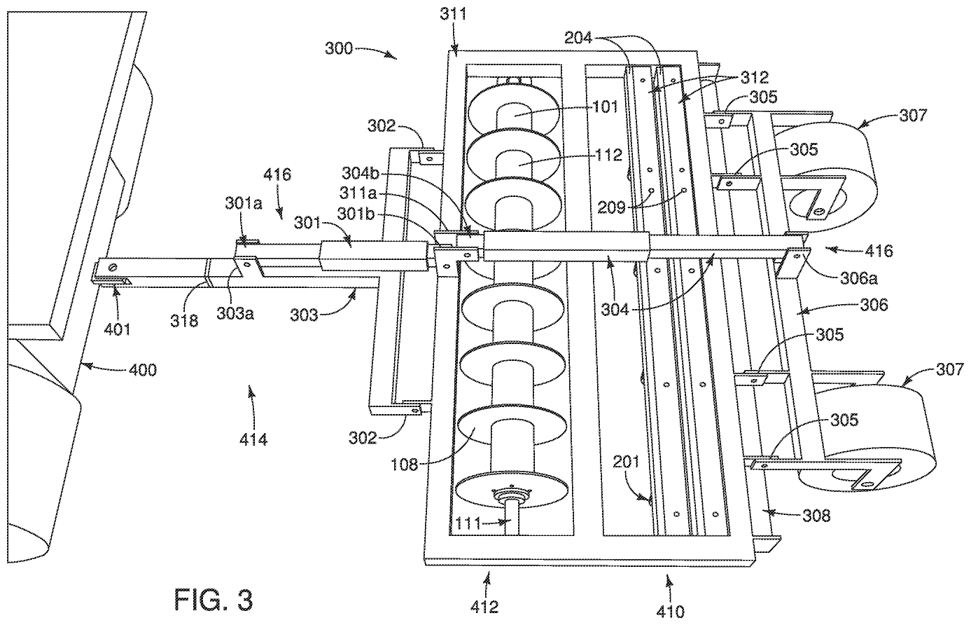

Referring to FIGS. 2 and 3, additional details of an underside and topside of an example embodiment of tow unit 400, treatment apparatus 300 and coupling assembly 414 therebetween are shown. In the depicted embodiment, energy storage unit 403 includes an interface connection 404 that is configured to couple with cables 501 to supply electrical energy from energy storage unit 403 to discharge assembly 500. The treatment apparatus 300 also includes a frame 311 for supporting components of the apparatus 300 including electrode assembly 410, preconditioning assembly 412, positioning assembly 416 and grooming assembly 308.

The illustrated preconditioning assembly 412 includes an axle 111, two split collars 109 (one on each end of the axle 111), two electrically insulative washers 110 (one on each end of the axle 111), eight pre-slicing members 108, four electrically insulative disc-carrying hubs 101, and three electrically-insulative spacers 112 in the illustrated example embodiment. Washers 100, hubs 101 and spacers 112 are electrically insulative (e.g., Nylon) to electrically isolate axle 111 from members 108 in one embodiment. Spacers 112 individually have a diameter of 4″ and a width that maintains 6″ spacing between members 108 in the illustrated embodiment.

Axle 111 is connected to pillow blocks 309 that are mounted on the treatment apparatus frame 311. Pillow blocks 309 include bearings 310 to facilitate rotation of axle 111 during movement of treatment apparatus 300.

In one embodiment, the pre-slicing members 108 are ground-driven during movement of apparatus 300 and are laterally spaced from one another on axle 111 in orientations that are substantially perpendicular to the direction of travel 602 of the apparatus 300. The number of members 108 is the same as the number of electrodes 201 and are spaced six-inches on center resulting in a treatment swath of 42″ in one embodiment. The spacing of members 108 is the same as the spacing of electrodes 201 which are mounted in trailing orientation in relation to the preconditioning assembly 412 during movement of apparatus 300 in the direction of travel 602. The electrodes 201 are aligned with the pre-slicing members 108 in one embodiment. Other numbers of pre-slicing members 108 and electrodes 201 may be utilized in other embodiments.

Pre-slicing members 108 may be constructed of any material (e.g., stainless steel) and thickness appropriate for sturdiness and durability as informed by the characteristics of the treatment location 601 and with an aim to minimize surface disturbance of the ground of the treatment location 601. In one embodiment, pre-slicing members 108 have a thickness of 0.0312″ to 1″, as well as a diameter to achieve a desired slicing depth, from 1″ to 20″ chosen based on the characteristics of the treatment location 601. In one more specific embodiment, the pre-slicing members 108 have a thickness of 0.0625″ to 0.125″ and are 8″ to 10″ in diameter with a blunt or sharpened knife shape edge 108a.

Two isolation members 204 of the electrode assembly 410 are mounted to two 90° angle steel members 312 that are mounted to frame 311 using electrically-insulative fasteners. Members 312 have orifices 209 that receive interconnects (not shown) for conducting electrical energy from discharge assembly 500 to the buss bars 203 of electrode assembly 410.

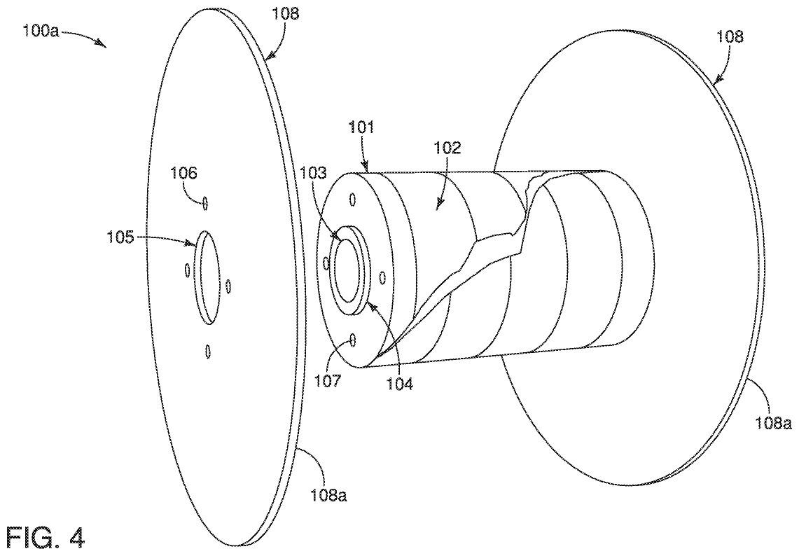

Referring to FIG. 4, additional details of a hub assembly 100a including a hub 101 coupled with two pre-slicing members 108 are shown according to one embodiment. The pre-slicing members 108 each have sharpened edges 108a, a 1.75″ diameter center bore 105 allowing for pre-slicing members 108 to slide over the shoulder machined on the hub 101, and four evenly spaced, drilled, and tapped clearance holes 106 for four ¼:20 bolts (not shown). The hub 101 of the assembly 100a has a 4″ outside diameter, a width of 6″, a 1.25″ diameter center bore 103 for use with a 1.25″ diameter metal axle 111, as well as four threaded holes 107 and a 1.75″×0.125″ shoulder 104, machined on both ends to support the members 108 which are bolted to both ends of hub 101 in the illustrated embodiment.

Hubs 101 are configured to contact and be driven by the ground and roll upon the surface of the treatment location 601 during movement of apparatus 300 over the treatment location 601 in one embodiment. A textured rubber coating 102 may be applied to the outside cylindrical surface of the hubs 101 to increase friction of assembly 100a with the surface of treatment location 601 and help facilitate rolling of hubs 101 during movement of apparatus 300.

During usage, the electrodes 201 of the electrode assembly 410 are engaged with and inserted into the ground of the treatment location 601 as treatment apparatus 300 traverses the treatment location 601 in the direction of travel 602 and hubs 101 contact the surface of treatment location 601 and roll as a result of the ground-drive action that turns the hubs 101 and members 108 coupled therewith as they traverse the treatment location.

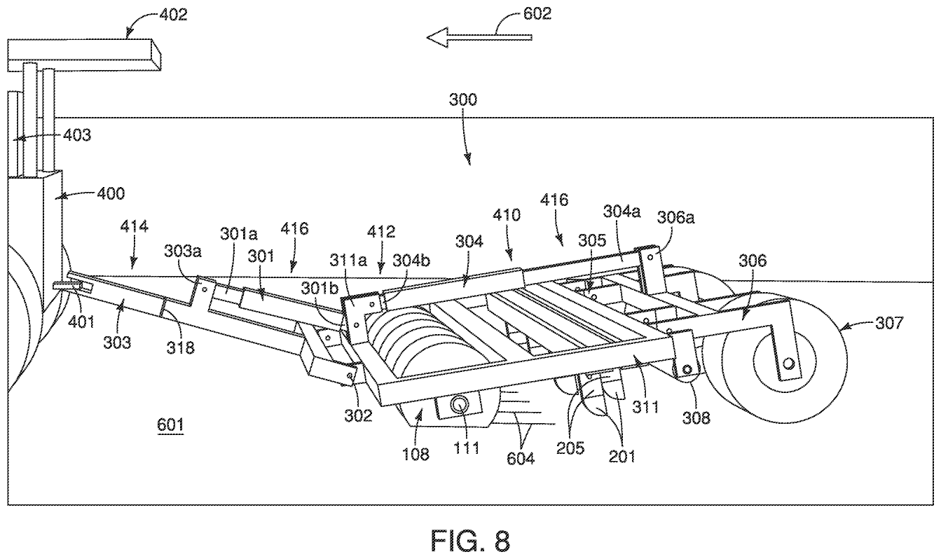

As discussed below, members 108 slice the surface of the treatment location 601 as the treatment apparatus 300 moves across the treatment location 601 creating pilot disturbances 604 (shown in FIG. 8). Electrodes 201 are aligned with members 108 and positioned to travel within the disturbances 604 during the traversal of the treatment location 601 by the treatment system 90.

In the described embodiment, the electrodes 201 of the electrode assembly 410 travel in pilot disturbances 604 rather than electrodes 201 themselves cutting the turf as provided in other embodiments where preconditioning assembly 412 is omitted. This usage of preconditioning assembly 412 reduces a heave effect or sideways displacement that the electrodes 201 alone would create, thus reducing surface disturbance and damage to plants in the treatment location 601.

The width of hubs 101 and spacers 112 provides a precise distance spacing between the members 108 of the preconditioning assembly 412, which are in alignment with electrodes 201 of the electrode assembly 410 that trail in disturbances 604 created by the members 108 of the preconditioning assembly 412 as the treatment apparatus 300 traverses the treatment location 601.

In addition, the diameters of the hubs 101 and spacers 112 are selected to control and maintain the depths of insertion of the pre-slicing members 108 into the ground of the treatment location 601 when the pre-slicing members 108 are fully engaged with the treatment location 601. Although hubs 101 and spacers 112 each have a diameter of 4″ and a width of 6″ in the described embodiment, it is understood that different diameters and widths may be selected to provide different electrode insertion depths below the surface of the treatment location 601 and different spacing between members 108. An example range of depths of insertion of electrodes 201 into ground of various treatment locations 601 is 1″-10″.

The center hole 105 of member 108 slides onto shoulders machined on the hub 101. The shoulder of the hub 101 provides electrical isolation and insulation from the axle 111 as well as structural support, reducing the shear force on the bolts securing the pre-slicing members 108 to the hub 101.

As mentioned above, washers 100, hubs 101 and spacers 112 are electrically insulative in the illustrated embodiment to ensure the pre-slicing members 108 are electrically isolated from the axle 111 and, by extension, the frame 311 or chassis of the treatment apparatus 300. This electrical isolation reduces or prevents any induced energy emitted from the electrodes 201 engaged with the treatment location 601 from energizing the frame 311 of the treatment apparatus 300 and further, the tow unit 400. Washers 100 are positioned between the outside of the outboard pre-slicing members 108 mounted to the outward-most hubs 101 further isolating the members 108 from the axle 111 by isolating the metal positioning collars 109 clamped to the axle 111 and preventing contact of the axle 111 and the outboard pre-slicing members 108.

Preconditioning assembly 412 is useful for treating treatment locations such as golf course fairway turf or similar conditions where the substrate material of the treatment location is more compacted compared with other substrates. The use of preconditioning assembly 412 reduces surface disturbance and plant damage caused by electrodes 201 moving through treatment location 601 in the absence of preconditioning assembly 412 and reduces the risk of phytotoxicity caused by the delivery of electrical energy to the treatment location 601 via electrodes 201 engaged with the treatment location 601. According to the above-described example embodiment, preconditioning assembly 412 slices soil or turf of treatment location 601 prior to exposure thereof to electrical energy from the electrodes 201.

The preconditioning assembly 412 described above according to one embodiment is but one possible method of reducing surface disturbance and plant damage in the treatment location 601 and other embodiments of the preconditioning assembly 412 may be used in other arrangements of the treatment apparatus 300. The preconditioning assembly 412 may be used for certain treatment locations so as to reduce or minimize surface disturbance and plant damage when the electrodes 201 are engaged with the treatment location and deliver electrical energy to the treatment location 601 while the treatment apparatus 300 is being moved across the treatment location.

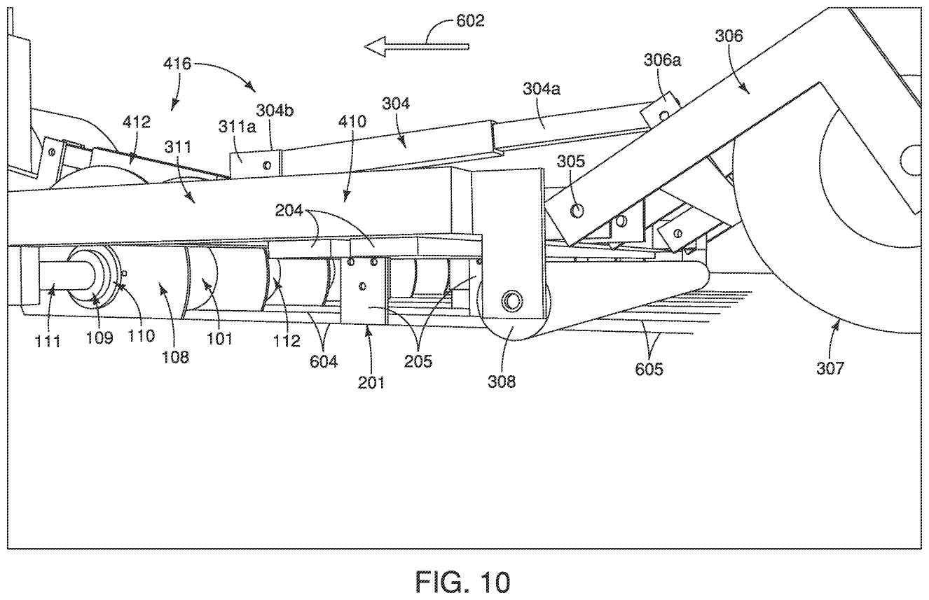

Grooming assembly 308 trails behind electrode assembly 410 in a direction of travel of apparatus 300. Grooming assembly 308 is configured as a roller in the illustrated embodiment to contact and roll upon the surface of the ground of the treatment location 601 following passage of preconditioning assembly 412 and electrode assembly 410 over the treatment location 601. The roller is configured to be driven by the surface of the ground during the traversal of the treatment location 602 by the treatment system 90. The grooming assembly 308 grooms or smooths a surface of the ground of the treatment location 410 disturbed by assemblies 412 and 410 during treatment. The grooming assembly 308 is helpful to reduce drying (and in turn browning) of the edges of the disruptions 604 created by the preconditioning assembly 412 and electrodes 201 by closing the disruptions 604 providing flattened and smoothed disruptions 605 shown in FIG. 10.

The preconditioning assembly 412 and/or grooming assembly 308 may be omitted in some embodiments of treatment apparatus 300.

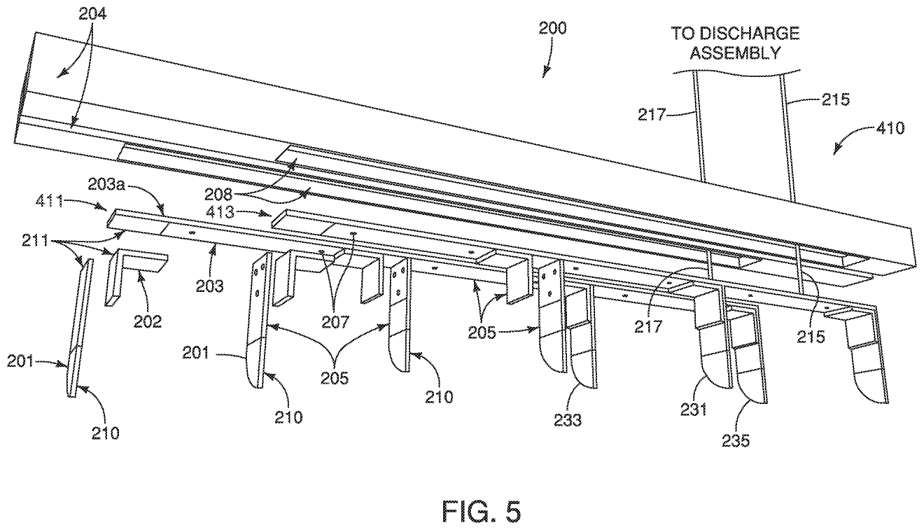

Referring to FIG. 5, one embodiment of an electrode assembly 410 is shown. The illustrated electrode assembly 410 includes two electrode sub-assemblies 411, 413 individually comprising a plurality of electrodes 201. In one embodiment, electrode sub-assembly 411 is biased at a positive voltage and electrode sub-assembly 413 is biased at a negative voltage.

The electrodes 201 are positioned at a plurality of different locations across a swath of the treatment location in a direction substantially perpendicular to direction of travel 602 of the treatment system 90. In one embodiment, the outermost electrodes 201 define a width of the swath of treatment location 601 being treated by the treatment apparatus. The electrodes 201 are provided at alternating opposing voltage polarities across the swath of the treatment location 601 in the illustrated embodiment.

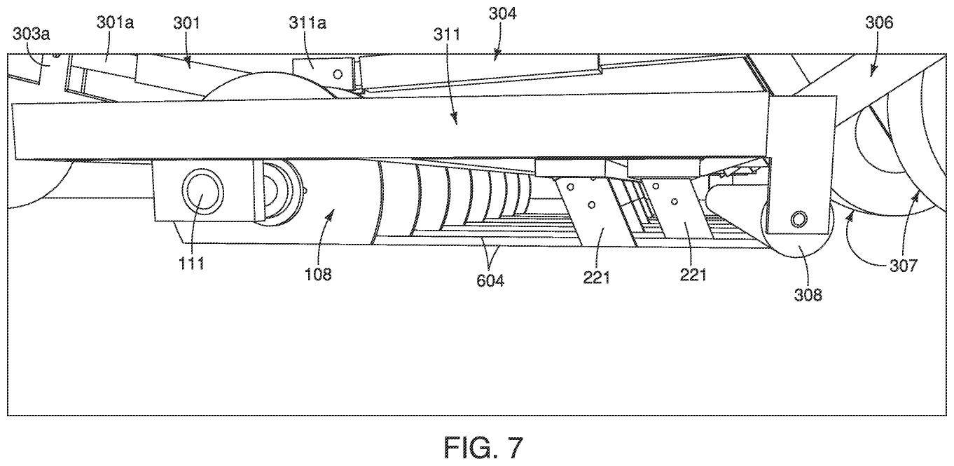

In addition, electrodes 201 extend outwardly and downwardly from apparatus 300 in directions that are substantially perpendicular with respect to a surface of the ground of the treatment location 601 in the depicted embodiment. Electrodes 201 extend outwardly from the respective electrode assembly 411, 413 at an angle with respect to a surface of the ground of the treatment location in other embodiments as shown for example in FIG. 7.

The electrodes 201 are configured to engage and deliver electrical energy generated by the discharge assembly 500 to the treatment location 601 during electrode engagement with the treatment location 601. Electrode orientation may refer to the vertical, longitudinal and lateral position of the electrodes relative to the surface of the treatment location for engagement and insertion into the treatment location 601. Once the electrodes 201 are engaged with the treatment location 601, the soil and/or matter of the treatment location 601 completes the circuit intermediate the electrodes 201. In particular, the insertion of the spaced electrodes 201 into the soil of the treatment location 601 in adjacent proximity to one another completes a circuit between the electrodes 201 to facilitate the delivery of the electrical energy from the discharge assembly 500 across the volume of soil between the exposed surfaces of the electrodes 201 that are inserted in the soil of the treatment location 601.

Each of sub-assemblies 411, 413 includes an isolation member 204 in the form of a non-conductive (e.g., Nylon) bar that is configured to electrically isolate a respective buss bar 203 from frame 311 of apparatus 300. The isolation members 204 are mounted to frame 311 using non-conductive fasteners. Buss bars 203 are fastened to respective members 204 using non-conductive fasteners that pass through clearance holes 207 and are fastened into corresponding threaded holes in member 204 (the fasteners are not shown in FIG. 5). Buss bars 203 are configured to conduct electrical energy from the source of electrical energy to the electrodes 201 and are provided at different electrical polarities during the traversal of the treatment location by the treatment system.

The non-conductive members 204 are mounted to a treatment apparatus frame or chassis, parallel to one another, at a distance of 1″ to 6″ apart, parallel to the surface of the ground of the treatment location 601, and substantially perpendicular to the direction of travel of the treatment apparatus 300 in the depicted embodiment. The members 204 are each fastened to a bar of 90° angle steel with non-conductive fasteners, to further ensure electrical isolation. Each bar of 90° angle steel is orientated so the horizontal side is on top and mounted to frame 311 with the vertical side of 90° angle steel positioned behind the trailing side of the members 204 to counter the resistance of the vertical electrodes 201 traveling in the disturbances 604.

In one embodiment, holes of an appropriate size and orientation are bored through members 204 to receive insulated, electrically conductive interconnects or cables 215, 217 or concealed rigid buss bars that conduct electrical energy from discharge assembly 500 to buss bars 203.

The buss bars 203 are positioned within recesses 208 of non-conductive members 204 of the sub-assemblies 411, 413 that are configured to electrically isolate the buss bars 203. The buss bars 203 are fastened to the non-conductive members 204 with non-conductive fasteners to further ensure electrical isolation.

In the depicted arrangement, four aluminum 90° angle mounts 202 are mounted to each of the buss bars 203 and that are further connected with respective electrodes 201. The electrode sub-assemblies 411, 413 are offset with respect to one another and electrodes 201 are positioned to alternate every 6″ in a direction that is substantially perpendicular to a direction of travel 602 of treatment apparatus 300 and across the treatment swath in the described embodiment. The electrodes 201 and angle mounts 202 of each sub-assembly 411, 413 are attached to the horizontal buss bar 203 using fasteners, welding or any practical method of attachment and are spaced 12″ apart on center in one embodiment.

In other embodiments, electrodes 201 of a given electrode assembly 411, 413 may be spaced from one another in a range from 2″ to 50″. Electrode assemblies 411, 413 may be mounted relative to one another such that the electrodes 201 of one electrode sub-assembly are at a distance of 2″ to 100″ from the electrodes 201 of an adjacent electrode sub-assembly. In some embodiments, the electrodes 201 have intermittent or continuous engagement with treatment location 601 during delivery of electrical energy to the full volume at the treatment location 601 between the electrodes 201.

As mentioned herein, electrodes 201 are configured to be inserted into the ground during the application of the electrical energy to the treatment location 601. In some embodiments, the electrodes 201 are configured, shaped and oriented to limit, minimize or prevent damage to the treatment location 601. Electrode designs may vary depending on the condition of the treatment location 601. For some treatment applications, such as utilization of apparatus 300 for applying electrical energy to a golf green, electrodes 201 are relatively thin and knife-shaped and the leading edge is sharpened to slice the turf of the treatment location 601 as the electrodes 201 are pulled through the treatment location. The electrodes 201 are configured to cut through the ground of the treatment location during the traversal of the treatment location by the treatment system in the illustrated embodiment.

Other example configurations of electrodes 201 that may be utilized include discs, pins, rings, spikes, blades, bars, plates, sheets, netting or any design suitable for engagement with a treatment location. The electrodes 201 comprise an electrically conductive material, such as steel, copper, aluminum, brass, bronze, gold, or any other suitable electrically conductive material. Some embodiments of the electrodes are made of aluminum or steel, to have a length or depth of between 0.1″ and 100″, a width dimension of between 0.1″ and 100″, and (where applicable) a diameter dimension of between 0.001″ and 5″. In addition, electrodes 201 may have a thickness of 0.0625″ more than the thickness of the pre-slicing members 108 (e.g., for an ⅛″ thick member 108 a corresponding electrode 201 may be 3/16″ thick) to provide continuous contact of exposed electrically conductive surfaces of electrodes 201 with the soil of the treatment location 601 to efficiently deliver the electrical energy to the treatment location 601. In the embodiment of FIG. 5, electrodes 201 have a curved profile at the tip, and with a sharpened leading edge to further reduce a sideways heave effect. Other configurations of the electrodes may be utilized in other embodiments.

In the illustrated embodiment, electrodes 201 having the same discharge polarity are configured in an array and coupled with one of buss bars 203 or are otherwise electrically connected to one another and are electrically connected to the discharge assembly 500. The individual electrode sub-assemblies 411, 413 are electrically isolated except where the discharge assembly 500 connects to them and where the electrodes 201 engage treatment location 601. Electrode sub-assemblies 411, 413 having the different polarities are oriented in relation to treatment location 601 and in relation to one another such that an electrical circuit between electrodes 201 and the treatment location 601 is completed when the electrodes 201 of electrode assemblies 411, 413 are engaged with a treatment location 601 thereby facilitating the discharge of electrical energy to the volume between the electrodes 201 having different electrical polarities.

Some embodiments described herein include electrode assemblies 411, 413 that are engaged with the same treatment location 601 in adjacent proximity to one another and which utilize the current and voltage carrying capabilities of the treatment location 601 to facilitate a discharge of one polarity of electrical energy generated by discharge assembly 500 from one electrode assembly 411 to an adjacent electrode assembly 413 that is discharging electrical energy of the opposite polarity generated by the same discharge assembly 500 to treatment location 601. The electrical resistance of the treatment location 601 avoids the occurrence of arc events resulting from the discharges generated by the discharge assembly 500 while the electrodes 201 of the electrode sub-assemblies 411, 413 are engaged with treatment location 601.

In the described embodiment, the electrodes are configured to remain in substantially constant engagement with the ground of the treatment location during the traversal of the treatment location by the treatment system as the electrodes are pulled through the ground of the treatment location. In one embodiment, the electrodes remain in substantially constant engagement with the ground of the treatment location from a starting location of the treatment location to an ending location of the treatment location.

Treatment apparatus 300 typically includes an even number of electrode sub-assemblies though some embodiments may employ an odd number of electrode sub-assemblies. Usually, the discharge polarities from a discharge assembly alternate from one electrode assembly to the other, either static (i.e., delivering pulses of the same pulse polarity to the same electrode assembly) or active (i.e., biphasic or bipolar pulses).

Each treatment location 601 poses unique challenges to engaging the electrodes 201 with the treatment locations 601 because of characteristics that vary from cropping system to cropping system, plant to plant and/or growing media to growing media. One complex characteristic is when plants are present and are to be protected while delivering electrical energy to other areas surrounding the plants of treatment location 601. Treatment apparatus 300 may be configured to in different embodiments for different applications. For example, electrode assembly 410 may be configured to accommodate, for example, straddling a row of raspberry canes or a wine grape trellis in order to deliver electrical energy across treatment location 601 in which they are planted.

In some embodiments, treatment apparatus 300 is configured to deliver electrical energy from discharge assembly 500 to golf and sports turf. Turf grass, including that grown in farming operations, and present on tennis courts, sports fields and golf courses, is susceptible to damage caused by organisms which reside in the soil. Fungal pathogens including Microdochium patch and Pythium among many others, and soil pests, including nematodes, crickets, grubs, mealy worms and other insects with a soil-borne phase, cause brown grass, bare spots and other stress indicators which impact appearance and playability. Controlling these harmful organisms has been an on-going challenge for growers and facilities' professionals because of the limited, even decreasing, efficacy of available conventional methods (primarily chemicals) as pests develop resistance. Some embodiments of treatment apparatus 300 disclosed herein are effective at controlling harmful organisms in the roots and soil of golf and sports turf, with results comparable to control achieved by fumigant nematicides. In addition, the target organisms are unable to develop resistance to the electrical energy applied by treatment apparatus 300. Conventional fumigants are applied by injecting chemicals below the surface of the turf that may result in brown stripes where the applied chemical burns the turf. The burning is actually phytotoxicity where the chemical kills the turf where the chemical is most concentrated and may take up to a week or more for the resulting stripes to disappear. This is one example of how current conventional methods fail to protect the plant in place in the treatment location.

Example treatment apparatuses 300 discussed herein are effective at controlling harmful soil-borne organisms including those mentioned above and are ideal for turf grass applications. However, because appearance and/or playability are commodities of this particular cropping system, some embodiments of the treatment apparatus 300 described below are configured to apply electrical energy in a manner that reduces or minimizes turf damage and limits disruption of the playing surface.

In particular, still referring to FIG. 5, buss bars 203 and electrodes 201 of electrode sub-assemblies 411, 413 may be partially or fully coated with an abrasion resistant dielectric coating 205 in some embodiments to further insure electrical isolation and safety.

In at least one embodiment, dielectric coating 205 is applied to all of the exposed surfaces of the electrode sub-assemblies 411, 413 in between non-conductive members 204 and the surface of the treatment location 601 when the electrodes 201 are engaged with the treatment location 601 and the treatment apparatus 300 traverses the treatment location.

Conductive pathways 211 are provided within the otherwise electrically isolated electrode assembly 410 and include mating surfaces 211 of buss bars 203, 90° angle mounts 202 and electrodes 201, which when mechanically fastened together, provide the conductive pathways 211 for electrical energy supplied from the discharge assembly to be passed to exposed surfaces 210 of the electrodes 201.

An example dielectric coating is PLASCOAT PPA 571 ES available from Axalta Coating Systems. Dielectric coating 205 is utilized to reduce or minimize phytotoxicity for plant protection and safety in some embodiments and may be applied to all above-ground surfaces of electrode assembly 410 in the described embodiment to protect from incidental contact. One method of applying the coating 205 is described below.

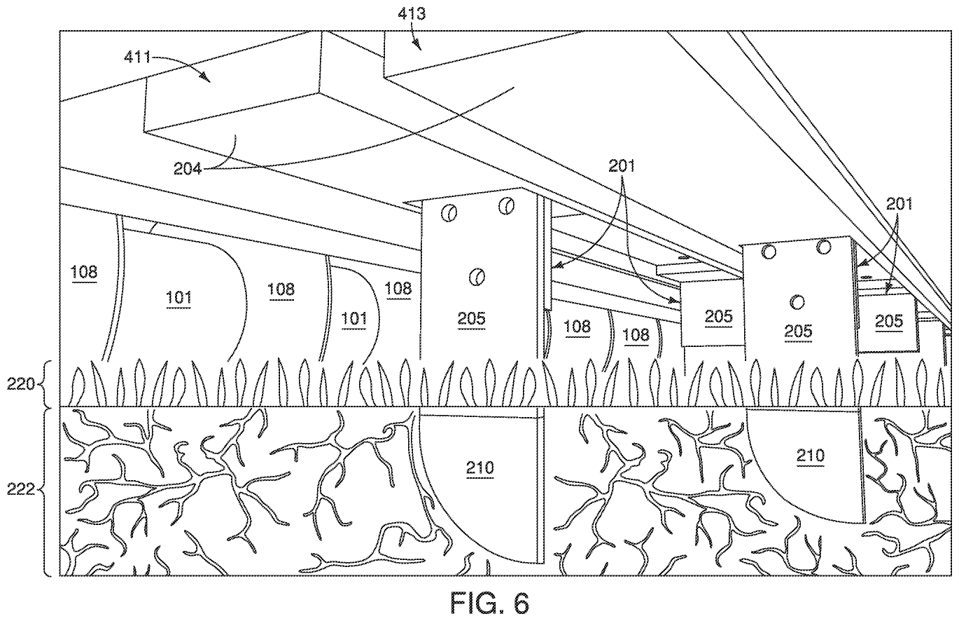

Referring to FIG. 6, exposed, electrically conductive portions 210 of the electrodes 201 are engaged with treatment location 601 below the surface thereof, and the electrically isolated portions having the dielectric coating 205 of the electrodes 201 are adjacent to the thatch layer and leaf and crown portions of the plant when electrical energy is supplied to the treatment location 601 in the described embodiment. The electrodes 201 are configured to shield and protect some portions of plants in the treatment location 601 while exposing other portions of the plants to electrical energy. In the illustrated embodiment, electrode sub-assemblies 411, 413 and upper portions of the illustrated electrodes 201 have a dielectric coating 205 to reduce phytotoxicity during treatment and lower portions of the electrodes 201 are exposed electrically conductive surfaces 210. The dielectric coating 205 is configured to shield at least part of plants in the ground of the treatment location 601 from the electrical energy applied to the ground of the treatment location 601. In particular, the dielectric coating 205 at the upper portion of electrodes 201 shields the thatch layer and leaf and crown portions 220 of the plants while applying the electrical energy to areas in the ground adjacent to the roots of the plants and adjacent soil in a zone 222. As shown, the electrically isolated part of the electrodes 201 are adjacent to and engage the thatch layer and leaf and crown portions 220 of the plants so as to protect the sensitive parts of the plants from the applied electrical energy for treatment by reducing the applied electrical energy to the thatch layer and leaf and crown portions 220 of the plants and delivering the electrical energy to the roots of the plants in zone 222 below.

In one example implementation of treating turf grass, there are no exposed, electrically conductive surface 210 of electrodes 201 visible during treatment as the conductive surfaces 210 of electrodes 201 are beneath the surface of treatment location 601. In addition, the dielectric coating 205 protects the sensitive parts of the turf grass that are in the layer 220 just beneath the surface of treatment location 601. Electrical energy (e.g., generated by discharge assembly 500) is delivered to the roots in zone 222 between electrodes 201 of first sub-assembly 411 and electrodes 201 of second sub-assembly 413 to treat treatment location 601. Accordingly, an increased amount of electrical energy is delivered to portions of the plant in including the roots in zone 222 compared with an amount of electrical energy applied to the thatch layer and leaf and crown portions of the plants 200.

The electrodes 201 are configured to conduct a current through the ground at the treatment location 601 in one embodiment.

Utilization of coating 205 according to some embodiments herein is useful for different purposes. First, the exposed, electrically conductive portions of electrodes 201 engage the soil below the thatch layer and leaf and crown portions 220 of the plants concentrating the electrical energy supplied by discharge assembly 300 in the root zone of treatment location 601. By isolating areas of the surface of the electrodes 201, electrical energy from discharge assembly 500 is concentrated below the surface of treatment location 601 where it is desired for the electrical energy to delivered for treatment even when the electrodes 201 are engaged with areas of treatment location 601 where the electrical energy is not to be delivered. For example, the dielectric coating 205 is applied to upper portions of electrodes 201 in the embodiment of FIG. 6 that is configured to isolate and protect the thatch layer and leaf and crown portions 220 of the plants as the electrodes 201 engage the treatment location 601 and deliver electrical energy to areas beneath the protected area of the turf (thatch layer and leaf and crown portions of the plants) of the treatment location 601 where the exposed, electrically conductive, surface area(s) of the electrodes 201 are engaged with the roots and soil of the treatment location 601 where the electrical energy is delivered for treatment. The dielectric properties of the coating 205 prevent the delivered electrical energy from concentrating in the thatch layer and leaf and crown portions 220 of the plants and potentially damaging the sensitive structures of the plants, thus reducing or minimizing the risk of phytotoxicity.

Second, by applying the coating 205 to the electrodes 201 to isolate portions of the electrode surfaces, the uncoated, exposed, electrically conductive surfaces of the electrodes 201 may be optimized to deliver example electrical energy to the treatment location which has a predetermined range of resistance as measured in Ohms. Reducing the area of exposed electrode surface by applying the coating 205 to a larger area of the electrode's overall surface has the effect of raising the amount of resistance in a treatment location. It has been observed that this increased resistance improves the efficient delivery of electrical energy generated by discharge assembly 500 to treatment location 601.

Electrical resistance between the electrodes 201 and the treatment location 601 may be measured and utilized to determine efficient delivery of electrical energy from the discharge assembly of the apparatus 300 to the treatment location 601. The electrical resistance is directly impacted by the amount of exposed, electrically conductive, surface area of the electrodes 201 engaged with the treatment location 601. The combined electrically conductive surface area of all exposed surfaces of one electrode 201 may range between 0.001 square inches and 10,000 square inches to provide an electrical resistance with an example range of 1 to 100 k Ohms between the electrodes 201 and treatment location 601. The range of the combined electrically conductive surface area of all exposed surfaces of one electrode 201 may be determined by the resistance, as measured in Ohms, present in a treatment location 601, and varies from treatment location to treatment location based on the characteristics present.

Prior to applying dielectric coating 205, components of electrode assembly 410 (e.g., buss bar 203, angle mounts 202, and electrodes 201) are assembled using metal fasteners (not shown). Next, top 203a of horizontal buss bar 203 and the bottom two inches or less of electrodes 201 are masked. Finally, dielectric coating 205 is applied in powder form to the entire electrode assembly 410 and the assembly 410 is heated per specifications of the dielectric coating 205, cooled, and the masking removed to expose the metal on the top 203a of the buss bar 203 and the exposed portions 210 of the electrodes 201. The dielectric coating 205 (once heated and cooled) encapsulates the coated portions of electrode assembly 203 in a void-free coating that is highly abrasion resistant and dielectrically strong (e.g., 1.21 kV/mil at 15 mils).

Although some example electrodes 201 discussed herein remain in constant engagement with the treatment location 601 by cutting or rolling continuously through the treatment location 601 while being towed by a tow unit 400, the treatment apparatus 300 may be configured such that the electrodes 201 can be temporarily, repeatedly inserted (reciprocated) into the treatment location 601 in other embodiments.

The electrodes 201 are oriented substantially perpendicular with respect to the frame 311 and surface of the ground in the above-described embodiment of FIG. 5. The electrodes 201 may be angled relative to frame 311 and the surface of the ground in other embodiments for example as shown in FIG. 7.

In example embodiments, leading edges of electrodes 201 may be oriented substantially perpendicular (i.e., 90°) relative to a surface of the ground of the treatment location 601 as discussed above. Referring to FIG. 7, electrodes 221 are oriented relative to the frame to be non-perpendicular with respect to frame 311 and surface of the treatment location 601. In example embodiments, the electrodes 201 are mounted to apparatus 300 such that the top of the leading edges of electrodes 221 lead and the bottoms of the electrodes 221 trail during traversal of the treatment location 601. In some embodiments, the leading edges of the electrodes 221 are positioned at an angle ranging from 20° to 160° relative to the surface of the ground of the treatment location 601. In more specific embodiments, the angles of leading edges of the electrodes 201 are each approximately 105-114 degrees relative to the surface of the treatment location 601 to enhance slicing action of electrodes 221 and reduce disruption to the surface of the ground treatment location 601 while the electrodes 221 are pulled through the treatment location 601. Utilization of angled electrodes 221 may reduce the heave effect and reduce surface disturbance compared with some arrangements where the electrodes are oriented substantially perpendicular to the surface of the ground of treatment location 601.

Optimum design of electrodes 201, including the amount of exposed, electrically conductive, surface area, orientation, angle in relation to the treatment location 601, and configuration may be determined by the characteristics of the treatment location 601 to be treated.

The discussion proceeds with respect to an example embodiment of positioning assembly 416 that may be utilized in some embodiments. The positioning assembly 416 is configured to control and selectively adjust a height of the electrodes 201 relative to a surface of the treatment location 601. The positioning assembly 416 is configured to selectively raise and lower front and rear portions of treatment apparatus 300 with respect to the surface of the ground during treatment as discussed below. The illustrated positioning assembly 416 includes a front actuator 301 and a rear actuator 304 that are individually controlled to selectively raise and lower respective front or leading and rear or trailing portions of frame 311, respectively.

Referring to FIG. 8, front actuator 301 is used to adjust a height of a front portion of treatment apparatus 300 relative to treatment location 601 in one embodiment. In the depicted configuration, front actuator 301 is configured to adjust the angle of drawbar 303 on the front of the treatment apparatus frame 311. As discussed below, the front actuator 301 is configured to selectively retract and extend to respectively lower and raise the front of the treatment apparatus frame 311 to engage and disengage the preconditioning assembly 412 with the treatment location 601. Other embodiments of assembly 412 are possible including use of solid bars mounted in slotted holes to exaggerate the angle of the drawbar 303 and treatment apparatus frame 311.

Front actuator 301 is configured to operate between an extended mode and a retracted mode. In the illustrated embodiment, a piston rod 301a of front actuator 301 is mounted to a piston rod mount 303a on the top of drawbar 303 and a fixed end 301b of actuator 301 is mounted to mount 311a on top of treatment apparatus frame 311 via respective bolts or clevis pins. Mount 311a operates as a fulcrum during operation of actuator 301.

During operation in the extended mode, piston rod 301a of front actuator 301 is provided in an extended position which holds the preconditioning assembly 412, electrode assembly 410 and grooming assembly 308 above and disengaged from the treatment location 601 as shown in FIG. 1.

During operation of front actuator 301 in the retracted mode as shown in FIG. 8 (with rear actuator 304 in the extended mode), piston rod 301a of front actuator 301 is provided in a retracted position which pivots about mount 311a and drawbar 303 pivots about connection 302 and lowers the front of frame 311. The lowering action of the front of frame 311 engages preconditioning assembly 412 with treatment location 601 where pre-slicing members 108 of preconditioning assembly 412 begin slicing and penetrating the surface of treatment location 601 to form disturbances 604 as the apparatus 300 traverses the treatment location 601. The larger diameter pre-slicing members 108 engage and penetrate the ground of the treatment location 601 prior to engagement of the surface of the ground of the treatment location 601 by hubs 101 and spacers 112.

As tow unit 400 pulls treatment apparatus 300 in the direction of travel 602, pre-slicing members 108 are engaged with treatment location 601 and roll and slice the surface of the turf forming a plurality of disturbances 604 in treatment location 601. Front actuator 301 is held in this retracted position while the treatment apparatus 300 is pulled by the tow unit 400 and rear actuator 304 is operated to engage electrodes of electrode assembly 410 with treatment location 601 as discussed below according to one embodiment.

Rear actuator 304 is used to adjust a height of a rear portion of treatment apparatus 300 relative to a surface of the ground of treatment location 601 in the illustrated embodiment. Rear actuator 304 is configured to retract and extend to respectively lower and raise the rear portion of the treatment apparatus 311 and engage and disengage the electrodes 201 with the pilot disturbances 604 formed by the members 108 and grooming assembly 300 with the surface of the treatment location 601.

Rear actuator 304 is configured to operate between an extended mode and a retracted mode in the illustrated embodiment. As shown, a fixed end 304b of rear actuator 304 is mounted to fixed-end mount 311a on top of the frame 311 via a bolt or clevis pin which serves as a fulcrum during operation of actuator 304. Piston rod 304a of rear actuator 304 is mounted to piston rod mount 306a on the top of a wheel carriage 306.

During operation of rear actuator 304 in the extended mode, piston rod 304a of rear actuator 304 is provided in an extended position which holds the electrode assembly 410 and grooming assembly 308 above and disengaged from the treatment location 601 as shown in FIG. 8.

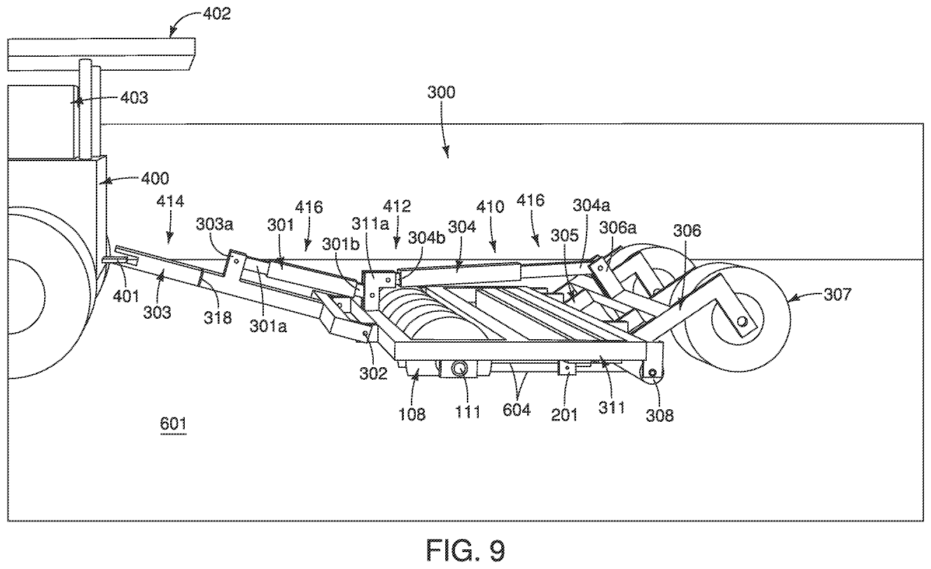

During operation of rear actuator 304 in the retracted mode as shown in FIG. 9, piston rod 304a of rear actuator 304 is shown in a retracted position and wheel carriage 306 pivots about connection 305 of frame 311 which lifts wheel carriage 306 and lowers the rear of frame 311 engaging electrodes 201 and grooming assembly 307 with the treatment location 601. The actuator 304 is programmed to stop retracting at a predetermined point where the tires 307 mounted in the wheel carriage 306 maintain the treatment apparatus 300 at an appropriate height relative to the surface of the ground of the treatment location 601 and the desired depth of electrodes 201 into the ground of the treatment location 601.

In the described embodiment, front actuator 301 is configured selectively engage preconditioning assembly 412 with the ground of the treatment location 61 and rear actuator 304 is configured to selectively engage electrodes 201 with the ground of the treatment location 601.

In one embodiment, the electrodes 201 are aligned with and trail behind pre-slicing members 108 during movement of apparatus 300 in the direction of travel 602 during treatment of location 601. The electrodes 201 engage treatment location 601 and travel in disturbances 604 formed by pre-slicing members 108 in the illustrated embodiment.

In addition, the engaged electrodes 201 conduct electrical energy with respect to the treatment location 601 as the treatment apparatus 300 moves across the treatment location 601. Disc-carrying hubs 101 of preconditioning assembly 412 and rear grooming assembly 308 are also engaged with the surface of treatment location 601 when rear actuator 304 is in the retracted position shown in FIG. 9.

The front actuator 301 and rear actuator 304 remain in the retracted positions until the treatment apparatus 300 reaches the end of the treatment location 601 whereupon the front actuator 301 and rear actuator 304 each return to their respective extended modes where the front and rear portions of the apparatus 300 are raised and disengaging the electrode assembly 410, preconditioning assembly 412, and grooming assembly 307 from the surface of the ground of the treatment location 601.

Referring to FIG. 10, both front actuator 301 and rear actuator 304 are shown in retracted positions that fully engages the treatment apparatus 300 with the treatment location 601. In particular, the pre-slicing members 108, electrodes 201 and grooming assembly 308 are fully engaged with the surface of the treatment location 601.

In addition, hubs 101 of preconditioning assembly 412 are fully engaged with the surface of the treatment location 601 which causes them to roll as treatment apparatus 300 is pulled by tow unit 400 in the direction of travel 602. The ground-driven rolling of hubs 101 turns the pre-slicing members 108 attached to the sides of hubs 101 which facilitates the cutting action of the eight pre-slicing members 108 to dramatically reduce the heave effect as described above.

The fully engaged electrodes 201 follow in disturbances 604 created by pre-slicing members 108 as treatment apparatus 300 is pulled by tow unit 400 in the direction of travel 602. In the illustrated embodiment, the electrodes 201 are positioned such that the dielectric coating 205 of the electrodes 201 is engaged with and extends below a surface of treatment location 601.

Discharge assembly 500 supplies electrical energy to electrode assembly 410 and electrodes 201 which are engaged with the treatment location 601 and supply electrical energy to the treatment location 601 as the treatment apparatus 300 is towed across the treatment location 601 by a tow unit 400 at a determined rate, such as 1 foot-per-second (or slower) to 10 feet-per-second (or faster) in example embodiments.

Grooming assembly 308 is fully engaged with the surface of the treatment location 601 in FIG. 10 which causes it to roll as treatment apparatus 300 is pulled by tow unit 400 in the direction of travel 602. The grooming assembly 308 reduces or removes ridges of disturbances 604, smooths the surface of treatment location 601, assists with closure of pilot disturbances 604 left by pre-slicing members 108 and widened slightly by electrodes 201, and providing flattened and smoothed grooves 605 in the surface of the ground of treatment location 601. The engaged operation of grooming assembly 308 facilitates recovery of plants in treatment location 601.

When the treatment apparatus 300 reaches the end of the treatment location 601, the discharge assembly 500 is deenergized and no electrical energy is supplied to electrode assembly 410. Electrodes 201 of electrode assembly 410 are disengaged from the treatment location 601 by extending the front and rear actuators 301, 304 that elevationally lifts the front and rear portions of the frame 311 with respect to the surface of the treatment location 601 and also disengages the preconditioning assembly 412 and grooming assembly 308 from the surface of the ground of the treatment location. In particular, piston rod 301a of front actuator 301 is extended to raise pre-slicing members 108 from treatment location 601 and piston rod 304a of rear actuator 304 is extended to lower wheel carriage 306 and lift the back of frame 311 and electrodes 201 and grooming assembly 308 above the surface of the treatment location 601. Following disengagement of apparatus 300 from the treatment location 601 as shown in FIG. 1, the tow unit 500 may then reposition the treatment apparatus 300 with respect to the next treatment location for treatment thereof.

In some example embodiments described above, one or more layers of electrical isolation are utilized to ensure that electrical energy outputted by the discharge assembly 500 is delivered safely to the treatment location 601 in an open environment. For example, one or more of use of dielectric coating 205 applied to the electrode sub-assemblies 411, 413, mounting and isolating buss bars 203 of the electrode sub-assemblies 411, 413 in non-conductive members 204 and nonconductive disk-carrying hubs 101 and spacers 112 of the preconditioning assembly 412 as discussed above are illustrative examples of various configurations that may be implemented to assist with electrical isolation of frame 311 of treatment apparatus 300 from the electrical energy supplied by the discharge assembly 500 for treating the treatment location 601. This isolation protects equipment mounted to frame 311 of treatment apparatus 300 as well as the tow unit 400 and, by extension, operators of treatment apparatus 300.

In some embodiments, electrical insulation or isolation may be utilized to interrupt potential conductive paths via the drawbar 300 of treatment apparatus 300 to the tow unit 400 to further electrically isolate and protect the tow unit 400 and operator from the discharge of electrical energy from the discharge assembly 500. The drawbar 303 may be fabricated of steel in some embodiments and have the potential to conduct any stray or induced electrical energy that may escape one or more layer(s) of isolation present in the apparatus 300 and energize the tow unit 400. Accordingly, in some embodiments described below, coupling assembly 414 is configured to electrically isolate the tow unit 400 from the treatment apparatus 300.

Interruption of a potential conductive path provided by the drawbar 303 of the treatment apparatus 300 can occur at one end of the drawbar 303 or the other using physical separation, electrical isolation or both. In one embodiment described below, the drawbar 303 may be separated from a receiver that is coupled with the tow unit 400. Separating the drawbar 303 in this way has the effect of interrupting potential conductive paths from the treatment apparatus 300 to the tow unit 400. In addition, an electrically isolating structural connection link may be utilized to couple the drawbar 303 to the receiver of the tow unit 400 as discussed below to provide further electrical isolation between apparatus 300 and tow unit 400.

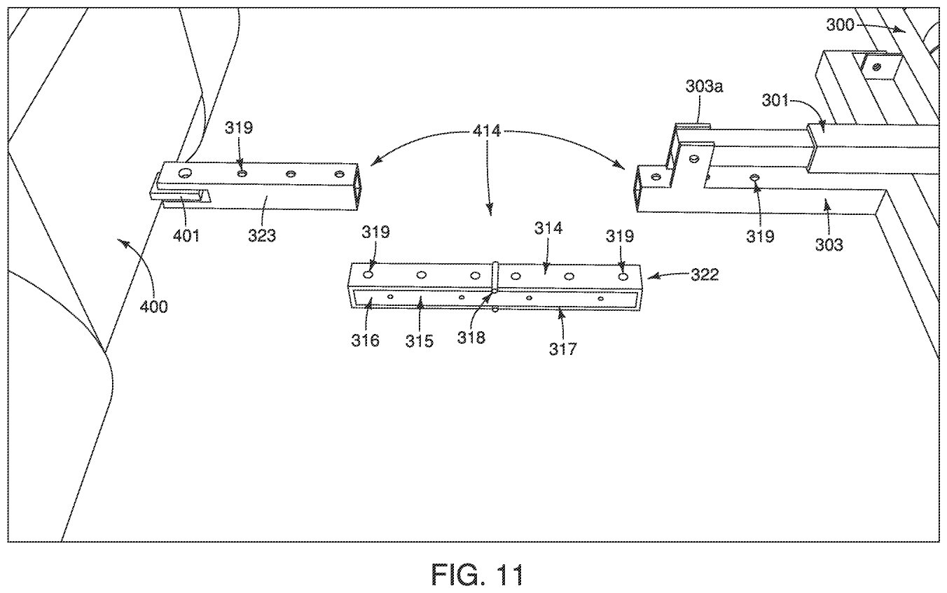

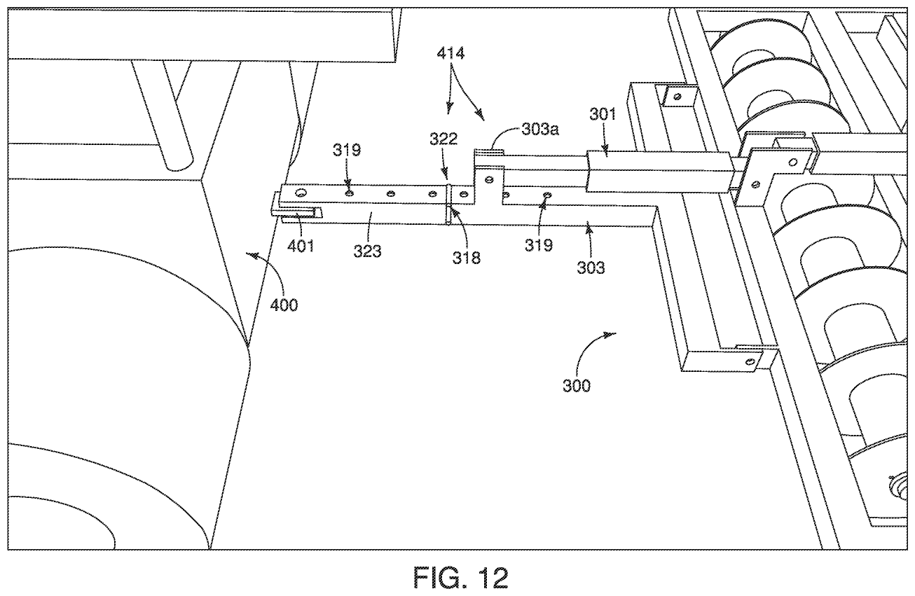

Referring to FIGS. 11 and 12, details are shown of one embodiment of coupling assembly 414. The illustrated coupling assembly 414 is configured to mechanically couple the apparatus 300 with tow unit 400 and to electrically isolate the frame 311 and components and assemblies coupled therewith from the tow unit 400.

The example coupling assembly 414 includes a connection link 322, receiver 323 of tow unit 400 and drawbar 303 of frame 311 of treatment apparatus 300. Connection link 322 is configured to mechanically couple with and provide electrical isolation between tow unit 400 and treatment apparatus 300 in one embodiment. More specifically, the described embodiment of coupling assembly 414 is configured to interrupt a potential electrical pathway between drawbar 303 of treatment apparatus frame 311 and tow unit 400. In one embodiment described below, connection link 322 is electrically insulative to provide electrical isolation between tow unit 400 and treatment apparatus 300 during treatment operations by using electrically insulative material reinforced with steel bars which are encapsulated in a dielectric coating.

Referring to FIG. 11, connection link 322 includes an electrically insulative bar 314 (e.g., Nylon) that has two recesses 317, one within each of opposing sides of link 322, that are configured to receive a respective reinforcing bar 315 (the reinforcing bar in the side of link 322 opposite to the illustrated bar 315 is not shown). In one embodiment, reinforcing bars 315 comprise steel to provide additional structural integrity to the connection link 322. A dielectric or electrically insulative coating 316 that may be the same composition as electrode coatings 205 described above may be applied to the outwardly-exposed surfaces of the steel bars 315 to further electrically isolate bars 315.

The illustrated bar 314 includes a rib 318 that physically separates and electrically isolates receiver 323 from drawbar 303 when installed as discussed below. Connection link 322, receiver 323 and drawbar 303 include a plurality of holes 319 clearanced to half-an-inch and drilled through the top and bottom surfaces thereof to receive appropriate bolts or other fasteners for coupling link 322 to receiver 323 and drawbar 303.

During operation, connection link 322 is inserted into receiver 323 and drawbar 303 as shown in FIG. 12. The holes 319 of receiver 323 and drawbar 303 are aligned with holes 319 of link 322 and respective bolts, washers and lock nuts or other fasteners (not shown) are installed in the holes 319 to securely couple the connection link 322 to receiver 323 and drawbar 303. Upon assembly of connection link 322 with receiver 323 and drawbar 303, rib 318 is positioned firmly against edges of receiver 323 and drawbar 303 thereby further electrically isolating the tow unit 400 from the treatment apparatus 300 in addition to the usage of electrically insulative bar 314 and insulative coating 316.

In one embodiment, insulative bar 314 of connection link 322 is fabricated from a 16.25″ piece of a 2″×2″ Nylon bar and 8″ of each end is machined to 1.75″×1.75″ corresponding to the inside dimensions of the drawbar 303 and receiver 323. The reinforcing bars 315 are each 15.75″×1.25″×0.125″ and mounted into two 15.75″×1.25″×0.1875″ recesses in the opposite, vertical sides of the bar 314 in the described embodiment. The recesses are machined 0.0625″ deeper than the 0.125″ thickness of the steel bars 315 to ensure the steel bars 314 will not contact the inside walls of the drawbar 303 and receiver 323. In one embodiment, reinforcing bars 315 are secured to insulative bar 314 with four nonconductive fasteners. The rib 316 may be 0.25″ thick and extend outwardly of all four sides of the bar 314 to electrical isolate open ends of drawbar 303 and receiver 323. The electrically isolating structural link 322 is configured to prevent any stray voltage from treatment apparatus 300 from energizing the tow unit 400 in the described embodiment.

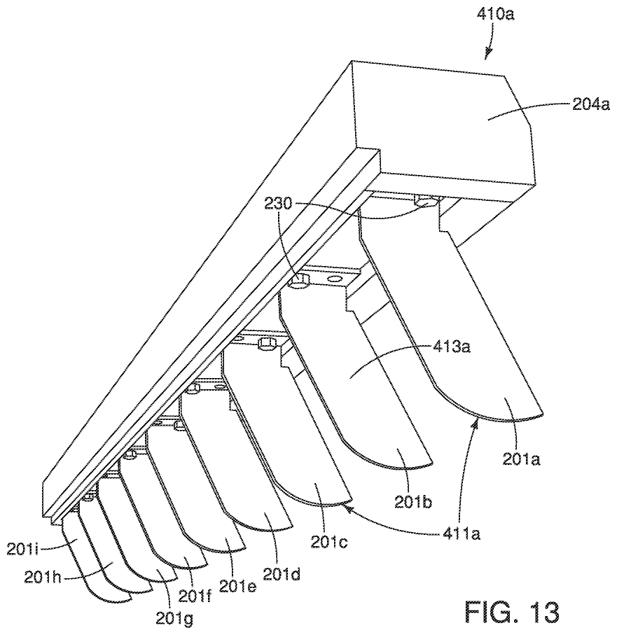

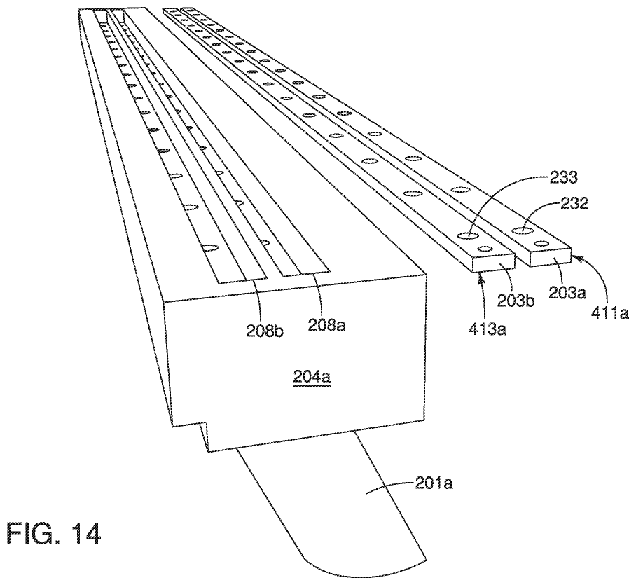

Referring to FIGS. 13 and 14, another embodiment of electrode assembly 410a is shown. The electrode assembly 410a includes a single isolation member 204a that includes a plurality of recesses 208a, 208b that are configured to receive and electrically isolate respective buss bars 203a, 203b.

Referring to FIG. 13, electrodes 201a-201i are aligned in a straight line that is substantially perpendicular to a direction of travel of apparatus 303 along a swath of the treatment location 601. In one embodiment, electrodes 201a, 201c, 201e, 201g, and 201i and buss bar 203a are biased at a common voltage potential (e.g., positive voltage bias) and electrodes 201b, 201d, 201f, and 201h and buss bar 203b are biased at a common voltage potential (e.g., negative voltage bias).

The electrodes 201a-201i (as well as the electrodes 201 of FIG. 5) are provided at alternating opposing voltage polarities across the swath of the treatment location 601 in the example disclosed embodiments. Pairs of adjacent electrodes (e.g., 201a and 201b) having the opposing voltage polarities form a plurality of respective voltage gradients across the swath of the treatment location 601 when the electrodes receive electrical energy from the discharge assembly and a current is conducted from the positive electrode to the negative electrode of the pair. Movement of the treatment system 601 moves the voltage gradients formed by the pairs of electrodes across the treatment location 601 during the traversal of the treatment location 601 by the treatment system.

A plurality of electrically conductive fasteners 230 (e.g., steel bolts) are used to electrically connect electrodes 201a, 201c, 201e, 201g, and 201i with buss bar 203a via orifices 232 and electrically connect electrodes 201b, 201d, 201f, and 201h, with buss bar 203b via orifices 233 in the illustrated embodiment. Electrically insulative fasteners (not shown) may additionally be utilized to fasten the electrodes 201a, 201c, 201e, 201g, and 201i with buss bar 203b via orifices 233 and fasten electrodes 201b, 201d, 201f, and 201h, with buss bar 203a via orifices 232 for additional structural integrity in one embodiment. Electrodes 201a, 201c, 201e, 201g, and 201i, buss bar 203a and respective fasteners 230 thereof may be referred to as a first electrode sub-assembly 411a and electrodes 201b, 201d, 201f, and 201h, buss bar 203b and respective fasteners 230 thereof may be referred to as a second electrode sub-assembly 413a.

The disclosed electrode sub-assemblies 411, 411a, 413, 413a of FIG. 5 and FIG. 13 provide respective electrodes at different locations along a swath of the treatment location 601 that extends in a direction that is substantially perpendicular to direction of travel 602 of apparatus 300 during treatment. The electrode sub-assemblies 411a, 413a provide electrodes 201a-201i along a single common line that is substantially perpendicular to direction of travel 602 and across a swath of the treatment location 601 being treated by the treatment apparatus.

The electrode sub-assemblies 411, 413 (and the electrode assemblies 411a, 413a) are each biased at different voltage levels during treatment operations. In one embodiment, electrode sub-assembly 411 (or 411a) is biased to a positive voltage while electrode sub-assembly 413 (or 413a) is biased to a negative voltage as described above. In other embodiments, one of the electrode assemblies is grounded and the other electrode assembly is biased to either a positive or negative voltage relative to ground.

In general, closest adjacent electrodes of opposite polarity of the electrode assemblies 410, 410a conduct currents between one another and through the volume of soil and other matter therebetween during treatment operations. For example, referring to FIG. 5, a positive electrode 231 may emit a current that is conducted to negative electrodes 233, 235 that are the closest adjacent electrodes to electrode 231. Referring to FIG. 13, a positive electrode 201c may emit a current that is conducted to electrodes 201b, 201d that are the closest adjacent electrodes to electrode 201c.

When the electrodes of the sub-assemblies 411, 411a, 413, 413a are engaged in the ground of treatment location 601 and the electrically conductive surfaces of the electrodes are in contact with the roots and soil (e.g., in the case of turf), the conducted currents travel primarily throughout the root zone between the closest adjacent electrodes of opposing polarity and the rhizosphere of the roots conduct a majority of the currents. Accordingly, in some embodiments, plants in the treatment location are provided in circuit with the adjacent electrodes and conduct currents between the adjacent electrodes. In the case of a fallow application where little or no root matter is present, the soil, minerals, etc. conduct the currents intermediate the closest adjacent electrodes.

The electrode assembly 410a disclosed in FIGS. 13 and 14 provides reduced volumes of soil and other matter between closest adjacent conducting electrodes (e.g., electrode 201a with respect electrode 201b) compared with volumes of soil and other matter between adjacent conducting electrodes of electrode assembly 410 (e.g., electrode 231 with respect to electrode 233 disclosed in FIG. 5) for a given spacing of electrodes (e.g., 6″) from one another in a lateral direction (i.e., the direction along a swath of the treatment location 601 that is substantially perpendicular to a direction of travel 602 of apparatus 303) since the electrodes of assembly 410a are assembled along a single common line compared with the electrodes 201 of assembly 410 that are assembled along plural lines that are parallel to one another. The presence of a reduced volume between conducting electrodes of assembly 410a of FIGS. 13 and 14 provides a decreased electrical resistance between the electrodes and enables treatment efficacies to be achieved that are similar to the arrangement of electrode assembly 410 of FIG. 5 with use of smaller voltage gradients.

In some embodiments, treatment apparatus 300 is configured to deliver bi-polar pulses of electrical energy to the ground during treatment of treatment location 601. Accordingly, discharge assembly provides a positive voltage pulse to electrode sub-assembly 411 (or 411a) while simultaneously providing a negative voltage pulse to electrode sub-assembly 413 (or 413a) in some embodiments. This allows for creation of larger voltage gradients between electrodes of sub-assemblies 411, 413 or electrodes sub-assemblies 411a, 413a while using smaller positive and negative voltage potentials relative to ground compared with arrangements that ground one of the electrodes and apply a larger total voltage bias of a single polarity to the other electrode to achieve the same total voltage gradient between the electrodes.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A treatment system comprising:
a frame;
a motion assembly coupled with the frame, and wherein the motion assembly is configured to enable the treatment apparatus to move to traverse over ground of a treatment location; and
an electrode assembly coupled with the frame, and wherein the electrode assembly comprises a plurality of electrodes configured to apply electrical energy to the ground of the treatment location during the traversal of the treatment location by the treatment system.

2. The treatment system of claim 1 wherein the electrodes are positioned at a plurality of different locations across a swath of the treatment location in a direction substantially perpendicular to a direction of travel of the treatment system during the traversal of the treatment location.

3. The treatment system of claim 2 wherein the electrodes are provided at alternating opposing voltage polarities in the direction substantially perpendicular to the direction of travel of the treatment system.

4. The treatment system of claim 3 wherein the electrodes are provided substantially along a common line.

5. The treatment system of claim 3 wherein a plurality of pairs of adjacent ones of the electrodes having the opposing voltage polarities form a plurality of respective voltage gradients across the swath of the treatment location.

6. The treatment system of claim 5 wherein the movement of the treatment system moves the formed voltage gradients through ground of the treatment location during the traversal of the treatment location by the treatment system.

7. The treatment system of claim 1 wherein the electrodes are configured to remain in substantially constant engagement with the ground of the treatment location during the traversal of the treatment location by the treatment system.

8. The treatment system of claim 7 wherein the electrodes are configured to remain in substantially constant engagement with the ground of the treatment location from a starting location of the treatment location to an ending location of the treatment location.

9. The treatment system of claim 1 wherein the electrodes are configured to cut through the ground of the treatment location during the traversal of the treatment location by the treatment system.

10. The treatment system of claim 1 wherein the electrodes are individually knife-shaped with a sharpened edge as a leading edge of the respective electrode.

11. The treatment system of claim 1 wherein the electrodes are configured to be inserted into the ground and are provided at different voltages during the application of the electrical energy to the ground.

12. The treatment system of claim 11 wherein upper portions of the electrodes have a dielectric coating and lower portions of the electrodes are exposed electrically conductive surfaces.

13. The treatment system of claim 1 wherein the electrodes are configured to shield at least part of a plant in the ground of the treatment location from the electrical energy applied to the ground of the treatment location.

14. The treatment system of claim 13 wherein the electrodes are configured to shield a thatch layer and leaf and crown portions of the plant while applying the electrical energy to areas in the ground adjacent to the roots of the plant.

15. The treatment system of claim 1 wherein the electrode assembly comprises a plurality of buss bars that are configured to conduct the electrical energy between a source of the electrical energy and the electrodes.

16. The treatment system of claim 15 further comprising at least one isolation member configured to electrically isolate the buss bars from the frame.

17. The treatment system of claim 16 wherein the buss bars are provided within respective recesses within the isolation member.

18. The treatment system of claim 15 wherein the buss bars are provided at different electrical polarities during the traversal of the treatment location by the treatment system.

19. The treatment system of claim 1 wherein the electrodes extend outwardly from the treatment system in directions that are substantially perpendicular with respect to a surface of the ground of the treatment location.

20. The treatment system of claim 1 wherein each of the electrodes extends outwardly from the treatment system at a non-perpendicular angle with respect to a surface of the ground of the treatment location.

21. The treatment system of claim 1 wherein the electrodes are configured to conduct a current through the ground at the treatment location.

22. The treatment system of claim 1 wherein the electrodes are configured to directly apply electrical currents to rhizospheres of roots of plants in the treatment location.

23. The treatment system of claim 1 further comprising a preconditioning assembly coupled with the frame, and wherein the preconditioning assembly is configured to generate a plurality of disruptions in the ground of the treatment location during traversal of the treatment location by the treatment system.

24. The treatment system of claim 23 wherein the preconditioning assembly is configured to generate the disruptions in the form of grooves.

25. The treatment system of claim 23 wherein the electrodes are positioned to travel within the disruptions during the traversal of the treatment location by the treatment system.

26. The treatment system of claim 23 wherein the preconditioning assembly comprises a plurality of pre-slicing members that are configured to form the disruptions in the ground of the treatment location.

27. The treatment system of claim 26 wherein the pre-slicing members are positioned at a plurality of different locations across a swath of the treatment location in a direction substantially perpendicular to a direction of travel of the treatment system during the traversal of the treatment location.

28. The treatment system of claim 26 wherein the electrodes individually have an increased thickness compared with thicknesses of the pre-slicing members.

29. The treatment system of claim 26 wherein the preconditioning assembly comprises a plurality of hubs, and the pre-slicing members are coupled with the hubs.

30. The treatment system of claim 29 wherein the hubs are configured to control depths of insertion of the pre-slicing members into the ground.

31. The treatment system of claim 29 wherein the hubs are configured to contact and be driven by the ground during the traversal of the treatment location by the treatment system.

32. The treatment system of claim 29 wherein the hubs are configured to control a spacing between the pre-slicing members along a swath of the treatment location.

33. The treatment system of claim 26 wherein the pre-slicing members are electrically isolated from the frame.

34. The treatment system of claim 26 wherein the pre-slicing members are discs.

35. The treatment system of claim 1 further comprising a positioning assembly coupled with the frame, and wherein the positioning assembly is configured to control a height of the electrodes relative to a surface of the ground of the treatment location.

36. The treatment system of claim 35 wherein the positioning assembly comprises:
a front actuator configured to selectively raise and lower a leading portion of the frame relative to the surface of the ground; and
a rear actuator configured to selectively raise and lower a trailing portion of the frame relative to the surface of the ground.

37. The treatment system of claim 36 wherein the front actuator is configured selectively engage a preconditioning assembly with the ground of the treatment location and the rear actuator is configured to selectively engage the electrodes with the ground of the treatment location.

38. The treatment system of claim 1 further comprising a grooming assembly, and wherein the grooming assembly is configured to smooth a surface of the ground of the treatment location.

39. The treatment system of claim 38 wherein the grooming assembly comprises a roller configured to contact and roll over the surface of the ground of the treatment location.

40. The treatment system of claim 39 wherein the roller is configured to be driven by the ground during the traversal of the treatment location by the treatment system.

41. The treatment system of claim 1 further comprising a coupling assembly coupled to the frame, and wherein the coupling assembly is configured to further couple with a tow unit, and wherein the coupling assembly is configured to electrically isolate the frame, the motion assembly and the electrode assembly from the tow unit.

42. The treatment system of claim 1 wherein the frame, motion assembly, electrode assembly are components of a treatment apparatus, and further comprising a tow unit configured to couple with the treatment apparatus and to pull the treatment apparatus.

43. The treatment system of claim 42 wherein the tow unit comprises a source of the electrical energy.

44. The treatment system of claim 1 further comprising a discharge assembly coupled with the frame and configured to control the application of the electrical energy to the ground of the treatment location.

45. The treatment system of claim 1 wherein the electrodes are configured to emit and receive an electrical current at different locations in the ground below a surface of the ground of the treatment location during the application of the electrical energy to the ground of the treatment location.

46. The treatment system of claim 45 wherein at least substantially an entirety of the electrical current is conducted through the ground below the surface of the ground of the treatment location.

47. The treatment system of claim 1 wherein the electrodes comprise an electrically insulative material at outer portions of the electrodes that are adjacent to a surface of the ground during the application of the electrical energy to the ground.

48. The treatment system of claim 1 wherein the electrodes are configured to emit and receive an electrical current at locations in the ground that are adjacent to roots of plants in the ground.

49. The treatment system of claim 1 wherein the electrodes are configured to emit and receive an electrical current at substantially the same depth below a surface of the ground of the treatment location.

50. The treatment system of claim 1 wherein at least one of the electrodes is provided at a positive voltage and at least one of the electrodes is provided at a negative voltage during the application of the electrical energy to the ground.

51. The treatment system of claim 20 wherein portions of the electrodes that are proximate to the frame lead the distal ends of the electrodes in a direction of travel of the treatment system.

52. The treatment system of claim 25 wherein the electrodes are provided at different voltages and the electrodes having the different voltages travel in different ones of the disruptions during the traversal of the treatment location.

53. The treatment system of claim 25 wherein the preconditioning assembly is positioned forward of the electrodes in a direction of travel of the treatment system.

54. The treatment system of claim 25 wherein the preconditioning assembly is configured to form the disruptions in the ground prior to the electrodes travelling in the disruptions during the traversal of the treatment location by the treatment system.

55. The treatment system of claim 41 wherein the coupling system comprises an electrically insulative bar and at least one reinforcing bar that are coupled with the frame and are configured to couple with the tow unit.

56. The treatment system of claim 55 wherein the electrically insulative bar comprises an electrically insulative rib configured to physically separate and electrically isolate the frame and the tow unit.
